(19) United States
(12) Patent Application Publication
(10) Pub. No.: US 2026/0258833 A1
(43) Pub. Date: Sep. 3, 2026

(54) FOIL BEARING DEVICE

(71) Applicant: MITSUBISHI HEAVY INDUSTRIES ENGINE & TURBOCHARGER, LTD., Sagamihara-shi, Kanagawa (JP)

(72) Inventors: Tasuku MASUDA, Tokyo (JP); Hideaki NISHIDA, Tokyo (JP); Takaya FUTAE, Tokyo (JP); Takuzo SHIGIHARA, Tokyo (JP); Rimpei KAWASHITA, Tokyo (JP); Naruhito HARADA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 19/156,272

(22) PCT Filed: Feb. 28, 2023
(86) PCT No.: PCT/JP2023/007297

§ 371 Date: Aug. 13, 2025

(51) Int. Cl. F16C 17/02

(52) U.S. Cl. CPC F16C 17/024; F16C 2360/44

(57) ABSTRACT

In the present invention, a foil bearing device that rotatably supports a rotating shaft comprises an annular member having an insertion hole through which the rotating shaft is inserted, a top foil of arcuate cross section that is positioned between the inner peripheral surface of the annular member and the outer peripheral surface of the rotating shaft so as to surround the entire outer periphery of the rotating shaft, and a bump foil that supports the top foil from the outer peripheral side of the top foil and that is supported on the inner peripheral surface of the annular member. In a cross-section perpendicular to the center line of the top foil, the top foil includes a first region in which at least one through hole formed through the top foil has an angular position of 240 degrees or more and less than 360 degrees, and a second region in which the angular position at which there are no through holes formed through the top foil is equal to or greater than 0 degrees and less than 240 degrees, if 0 degrees is regarded to be the angular position of a virtual line extending upward in the direction of gravity from the center line of the top foil, the angular position increasing as the imaginary line rotates in the direction of rotation of the rotating shaft with the center line of the top foil as the center of rotation, and 360 degrees is regarded to be the angular position when the imaginary line has completed one rotation.

### TECHNICAL FIELD

The present disclosure relates to a foil bearing device that rotatably supports a rotor.

### BACKGROUND ART

A foil bearing includes a top foil that configures a bearing surface for a rotor of a turbo blower or a turbo compressor, and a bump foil that elastically supports the top foil. When the rotor rotates, a fluid film (air film) is formed between the bearing surface of the top foil and the rotor, and the rotor is rotatably supported via the air film. Since an appropriate air film is automatically formed according to the rotation speed of the rotor, the foil bearing is particularly effective when applied to a rotor that rotates at a high speed.

In order to stably support the rotor with the air film, it is necessary to appropriately maintain the pressure of the air film. For example, PTL 1 discloses a foil bearing device including a valve that opens and closes a communication hole formed in a top foil according to a pressure (dynamic pressure) of an air film.

### CITATION LIST

### Patent Literature

[PTL 1] Japanese Unexamined Patent Application Publication No. 2021-046913

### SUMMARY OF INVENTION

### Technical Problem

The air film includes a region (reduced pressure region) in which the air film spreads toward a downstream side in a rotation direction of the rotor. In the reduced pressure region, the pressure of the air film becomes a negative pressure, and the negative pressure serves as an exciting force that vibrates the rotor, which may reduce the vibration stability of the rotor. However, PTL 1 suggests that when the dynamic pressure of the air film increases outside the reduced pressure region, the valve is opened to release the dynamic pressure to an outer peripheral side of the top foil, but does not suggest solving the problem of the generation of the negative pressure in the reduced pressure region.

The present disclosure has been made in view of the problems described above, and an object of the present disclosure is to provide a foil bearing device capable of improving vibration stability of a rotor.

### Solution to Problem

In order to achieve the above object, according to the present disclosure, there is provided a foil bearing device that rotatably supports a rotor, the foil bearing device including: an annular member having an insertion hole through which the rotor is inserted; a top foil having an arc-shaped cross section, which is disposed to surround an entire outer periphery of the rotor between an inner surface of the annular member and an outer surface of the rotor; and a bump foil that supports the top foil from an outer peripheral side of the top foil and that is supported on the inner surface of the annular member, in which, when in a cross section orthogonal to a center line of the top foil, an angular position of an imaginary line extending upward in a gravity direction from the center line of the top foil is set to 0 degrees, the angular position increases as the imaginary line rotates in a rotation direction of the rotor with the center line of the top foil as a rotation center, and the angular position when the imaginary line makes one rotation is defined as 360 degrees, the top foil includes a first region in which the angular position at which at least one through-hole penetrating the top foil is formed is in a range of 240 degrees or more and less than 360 degrees, and a second region in which the angular position at which a through-hole penetrating the top foil is not formed is in a range of 0 degrees or more and less than 240 degrees.

### Advantageous Effects of Invention

According to the foil bearing device of the present disclosure, it is possible to improve the vibration stability of the rotor.

### BRIEF DESCRIPTION OF DRAWINGS

FIG. 1 is a diagram schematically showing a configuration of an electric compressor including a foil bearing device according to some embodiments.

FIG. 2 is a cross-sectional view schematically showing a configuration of a foil bearing device according to one embodiment.

FIG. 3 is a developed view of an inner surface of a top foil according to one embodiment as developed and viewed.

FIG. 4 is a diagram showing an example of a state where a rotor shown in FIG. 2 is rotated.

FIG. 5 is a graph showing a relationship between an angular position corresponding to FIG. 4 and a pressure of an air film.

FIG. 6 is a developed view of an inner surface of a top foil according to another embodiment as developed and viewed.

FIG. 7 is a developed view of an inner surface of a top foil according to still another embodiment as developed and viewed.

FIG. 8 is a diagram schematically showing a configuration of a top foil according to still another embodiment.

### DESCRIPTION OF EMBODIMENTS

Hereinafter, a foil bearing device according to an embodiment of the present disclosure will be described based on the drawings. Such an embodiment shows one aspect of the present disclosure, does not limit this disclosure, and can be optionally changed within the scope of the technical concept of the present disclosure.

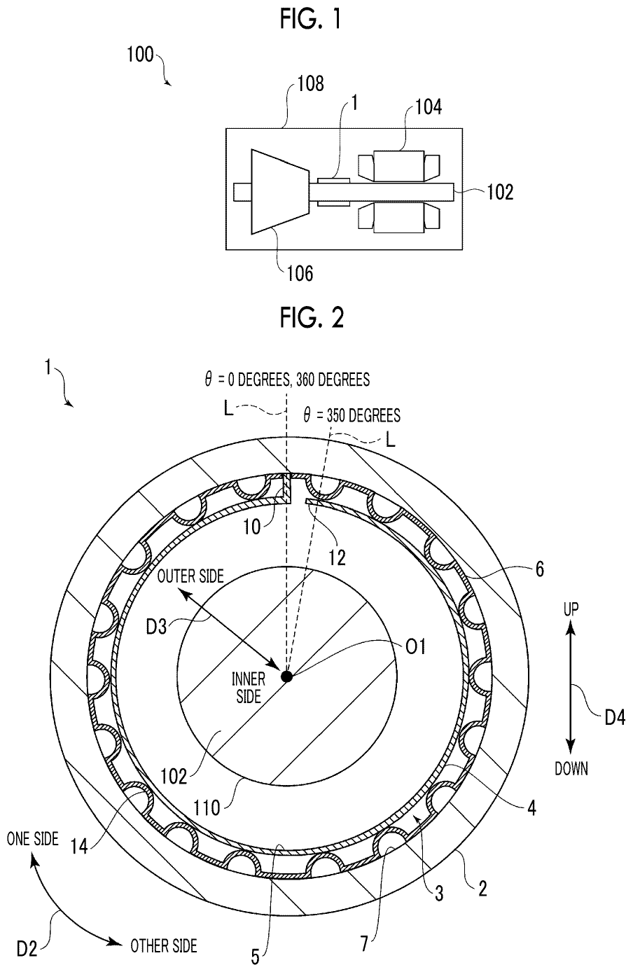

FIG. 1 is a diagram schematically showing a configuration of an electric compressor 100 including a foil bearing device 1 according to some embodiments. As illustrated in FIG. 1, the electric compressor 100 includes a rotor 102, an electric motor 104 that rotates the rotor 102, an impeller 106 that compresses a fluid by rotating integrally with the rotor 102, a housing 108 that accommodates the electric motor 104 and the impeller 106, and the foil bearing device 1.

The foil bearing device 1 rotatably supports the rotor 102. The foil bearing device 1 supports the rotor 102 in a state of being in contact with the rotor 102 until the rotation speed of the rotor 102 reaches a lift-off rotation speed at which the rotor 102 becomes suspended. When the rotation speed of the rotor 102 reaches the lift-off rotation speed, the foil bearing device 1 supports the rotor 102 in a non-contact state with the rotor 102 via a fluid film (hereinafter, referred to as an air film A) that is formed between an inner surface 5 (a bearing surface) of a top foil 4 and an outer surface 110 of the rotor 102.

In the present disclosure, a case where the foil bearing device 1 is applied to the electric compressor 100 is exemplified. However, a device to which the foil bearing device 1 is applied is not limited to the electric compressor 100. The foil bearing device 1 according to the present disclosure is applied to a rotating device including the rotor 102, particularly a rotating device including the rotor 102 that can rotate at a high speed. For example, the rotating device includes a turbocharger or a turbo blower.

### Foil Bearing Device

### Configuration

The configuration of the foil bearing device 1 according to one embodiment will be described. FIG. 2 is a cross-sectional view schematically showing the configuration of the foil bearing device 1 according to one embodiment, and shows the foil bearing device 1 cut in a direction orthogonal to an axial direction (hereinafter, referred to as an axial direction D1) of the rotor 102. As illustrated in FIG. 2, the foil bearing device 1 includes an annular member 2, the top foil 4, and a bump foil 6.

The annular member 2 has an insertion hole 3 through which the rotor 102 is inserted. In one embodiment, the annular member 2 has a cylindrical shape, and the inner diameter of the annular member 2 is larger than the outer diameter of the rotor 102. In some embodiments, the housing 108 of the electric compressor 100 described above includes the annular member 2. In this case, the annular member 2 is a part of the housing 108.

The top foil 4 has an arc shape and is disposed to surround the entire outer periphery of the rotor 102 between an inner surface 7 of the annular member 2 and the outer surface 110 of the rotor 102. The top foil 4 is formed, for example, by bending a flexible metal plate material made of stainless steel into a cylindrical shape. In the form illustrated in FIG. 2, one end portion 10 of the top foil 4 in a circumferential direction D2 (hereinafter, referred to as a “circumferential direction D2”) is bent outward in a radial direction D3 (hereinafter, referred to as a “radial direction D3”) of the top foil 4. The top foil 4 is disposed inside the annular member 2 in a state where the one end portion 10 in the circumferential direction D2 is held by the annular member 2. The other end portion 12 of the top foil 4 in the circumferential direction D2 is slightly separated from the one end portion 10 in the circumferential direction D2. In the form illustrated in FIG. 2, the top foil 4 is formed of a single metal plate material, and the outflow of the air film A from locations other than a through-hole 8 (to be described later) to the outside of the top foil 4 is eliminated. Therefore, the operation and effect to be described later can be easily obtained. However, the present disclosure is not limited to this form. Although not shown in the drawings, in some embodiments, the foil bearing device 1 includes a plurality of top foils 4 that are separate from each other and that are continuously disposed along the circumferential direction D2.

In the present disclosure, the circumferential direction D2 is a circumferential direction centered on a center line O1 of the top foil 4. In the paper surface of FIG. 2, a direction (leftward direction) toward the one end portion 10 from the other end portion 12 of the top foil 4 is defined as one side in the circumferential direction D2, and a direction (rightward direction) toward the other end portion 12 from the one end portion 10 of the top foil 4 is defined as the other side in the circumferential direction D2. The radial direction D3 is a direction perpendicular to the center line O1, and a direction approaching the center line O1 is defined as an inner side in the radial direction D3, and a direction separated from the center line O1 is defined as an outer side in the radial direction D3.

The bump foil 6 has an arc shape and is disposed to surround the entire outer periphery of the top foil 4. The bump foil 6 is supported on the inner surface 7 of the annular member 2. The bump foil 6 is formed, for example, by bending a flexible metal plate material made of stainless steel into a tubular shape. In the form illustrated in FIG. 2, the bump foil 6 extends over the entire circumferential direction D2 and is in contact with the inner surface 7 of the annular member 2. The bump foil 6 is configured to allow the one end portion 10 of the top foil 4 to pass through the bump foil 6. Although not shown in the drawings, in some embodiments, the foil bearing device 1 includes a plurality of bump foils 6 that are separate from each other and that are continuously disposed along the circumferential direction D2.

The bump foil 6 includes a plurality of bump portions 14 that protrude toward the top foil 4, and at least a part of the bump portion 14 abuts against the top foil 4. Each of the plurality of bump portions 14 protrudes in a direction separated from the inner surface 7 of the annular member 2 (that is, toward the inner side in the radial direction D3), and is bent in an arc shape. The top of each of the plurality of bump portions 14 abuts against the top foil 4. The plurality of bump portions 14 are arranged at intervals from each other along the circumferential direction D2, and the bump foil 6 has a corrugated shape. The bump foil 6 is made to elastically support the top foil 4.

As shown in FIG. 2, in a cross-sectional view obtained by cutting the foil bearing device 1 in a direction orthogonal to the axial direction D1 of the rotor 102, an angular position θ of an imaginary line L extending upward in a gravity direction D4 from the center line O1 of the top foil 4 is defined as 0 degrees. The angular position θ increases as the imaginary line L rotates with the center line O1 of the top foil 4 as a rotation center to the other side (counterclockwise) in the circumferential direction D2, which is the rotation direction of the rotor 102, and the angular position θ when the imaginary line L makes one rotation is defined as 360 degrees. In the form illustrated in FIG. 2, the other end portion 12 of the top foil 4 is located at the angular position θ of 350 degrees or more and less than 360 degrees.

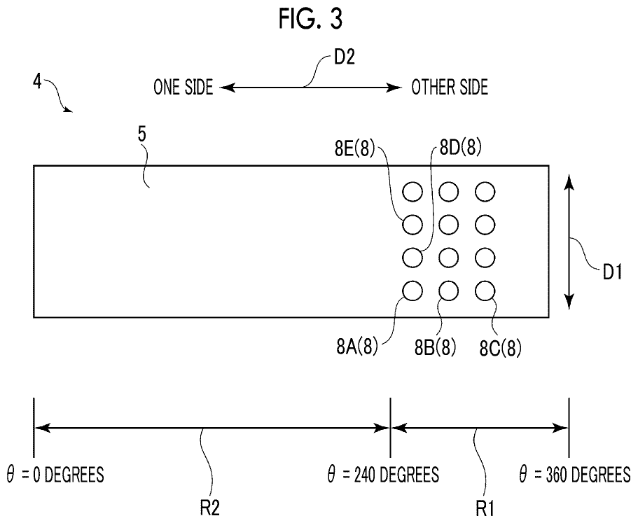

FIG. 3 is a developed view of the inner surface 5 of the top foil 4 according to one embodiment as developed and viewed. As shown in FIG. 3, the top foil 4 includes a first region R1 where the angular position θ is in a range of 240 degrees or more and less than 360 degrees, and a second region R2 where the angular position θ is in a range of 0 degrees or more and less than 240 degrees. In the first region R1, the top foil 4 has a plurality of through-holes 8 formed to penetrate the top foil 4. On the other hand, in the second region R2, the through-hole 8 penetrating the top foil 4 is not formed in the top foil 4.

In the form illustrated in FIG. 3, the plurality of through-holes 8 include, in the first region R1, a first through-hole 8A (8) and a second through-hole 8B (8) having the angular position θ different from the angular position θ of the first through-hole 8A. In other words, each of the first through-holes 8A and the second through-holes 8B is disposed along the circumferential direction D2. The first through-hole 8A and the second through-hole 8B at least partially overlap each other in the axial direction D1. The plurality of through-holes 8 further include a third through-hole 8C (8) that is disposed on the side opposite to the first through-holes 8A with the second through-hole 8B interposed therebetween in the circumferential direction D2. Each of the first through-hole 8A, the second through-hole 8B, and the third through-hole 8C has a circular shape having the same diameter as each other.

In the form illustrated in FIG. 3, the plurality of through-holes 8 include the first through-hole 8A and a first axial direction through-hole 8D (8), which are disposed along the axial direction D1, in the first region R1. The first through-hole 8A and the first axial direction through-hole 8D at least partially overlap each other in the circumferential direction D2. The plurality of through-holes 8 further include a second axial direction through-hole 8E (8) that is disposed on the side opposite to the first through-holes 8A with the first axial direction through-hole 8D interposed therebetween in the axial direction D1. Each of the first through-hole 8A, the first axial direction through-hole 8D, and the second axial direction through-hole 8E has a circular shape having the same diameter as each other.

### Operations and Effects

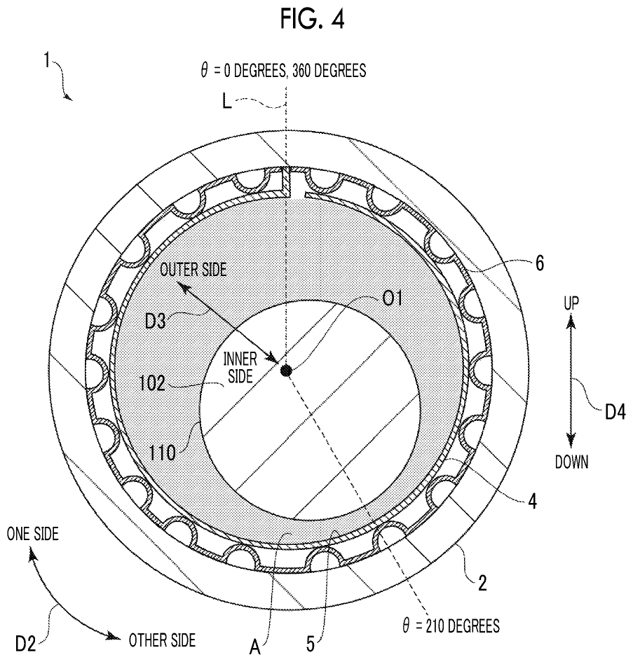

The operation and effects of the foil bearing device 1 according to one embodiment will be described. FIG. 4 is a diagram showing an example of a state where the rotor 102 shown in FIG. 2 is rotated, and the rotor 102 is rotated at a rotation speed equal to or higher than the lift-off rotation speed.

As shown in FIG. 4, the foil bearing device 1 supports the rotor 102 in a non-contact state with the rotor 102 via the air film A. The rotor 102 tends to fall due to its own weight. In addition, the rotor 102 approaches a portion at the angular position θ of 180 degrees or more of the inner surface 5 of the top foil 4 due to rotation. That is, in the paper surface of FIG. 4, the rotor 102 moves to the right due to rotation. For this reason, in a case illustrated in FIG. 4, the air film A becomes thinnest at the angular position θ of 210 degrees. The air film A is thinned toward the angular position θ of 210 degrees from the angular position θ of 0 degrees and is thickened toward the angular position θ of 360 degrees from the angular position θ of 210 degrees (the thickness of the air film A increases).

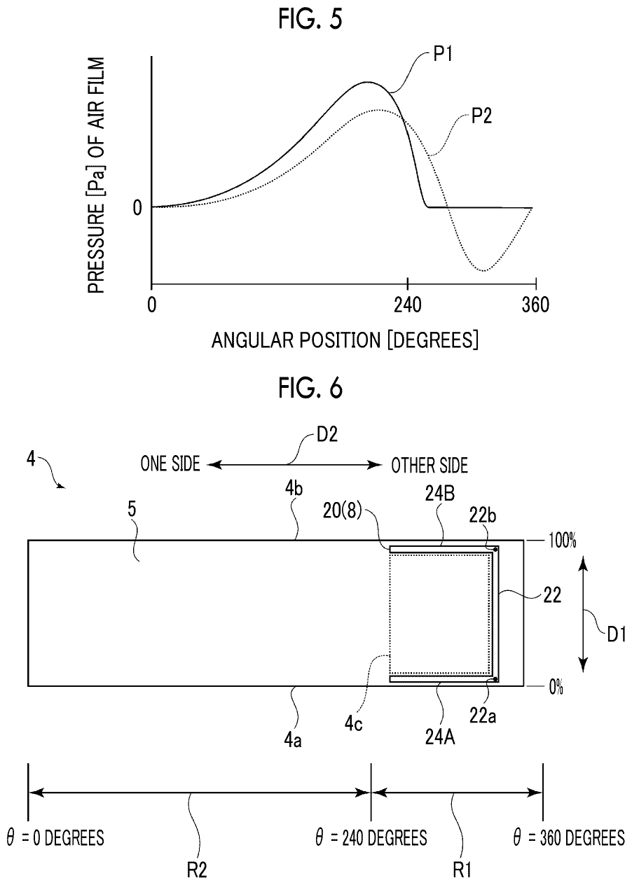

FIG. 5 is a graph showing a relationship between the angular position θ corresponding to FIG. 4 and the pressure of the air film A. In FIG. 5, the horizontal axis indicates the angular position θ, and the vertical axis indicates the pressure of the air film A. The pressure of the air film A in FIG. 5 is indicated with a gauge pressure, and becomes 0 Pa in a case where the pressure of the air film A is equal to the pressure (atmospheric pressure) around the air film A. Then, a pressure of less than 0 Pa is defined as a negative pressure, and a pressure of 0 Pa or more is defined as a positive pressure. In FIG. 5, the pressure of the air film A in a case where the rotor 102 is supported by the foil bearing device 1 according to one embodiment is P1, and is indicated by a solid line. In addition, the pressure of the air film A in a case where the plurality of through-holes 8 are not formed in the first region R1 of the top foil 4 (a comparative example) is P2, and is indicated by a dotted line.

As shown in FIG. 4, when the rotor 102 rotates, in the first region R1 where the angular position θ is in a range of 240 degrees or more and less than 360 degrees, the air film A becomes thinner as the angular position θ increases, and the pressure of the air film A decreases. For this reason, as shown in FIG. 5, in the first region R1, there is a possibility that the pressure of the air film A becomes a negative pressure. The negative pressure serves as an exciting force that vibrates the rotor 102, and reduces the vibration stability of the rotor 102.

According to one embodiment, since the plurality of through-holes 8 are formed in the first region R1 of the top foil 4, even when the pressure of the air film A becomes a negative pressure, the air on an outer peripheral side of the top foil 4 flows into the air film A through the plurality of through-holes 8, and the pressure of the air film A is prevented from becoming a negative pressure. That is, as shown in FIG. 5, the pressure of the air film A is prevented from becoming lower than 0 Pa. Therefore, it is possible to suppress an increase in the exciting force and to improve the vibration stability of the rotor 102.

Meanwhile, in a case where the through-holes 8 are formed over the entire periphery of the top foil 4, the pressure of the air film A supporting the rotor 102 is reduced, the air film A is thinned, and there is a concern that the rotor 102 may come into contact with the top foil 4. According to one embodiment, since the through-hole 8 is not formed in the second region R2 of the top foil 4, it is possible to suppress a decrease in the pressure of the air film A and to suppress contact between the rotor 102 and the top foil 4. In particular, as shown in FIG. 5, the air film A in the second region R2 is often under a positive pressure of 0 Pa or higher, unlike the air film A in the first region R1. Therefore, it is not necessary to allow air to flow into the air film A in the second region R2 through the through-hole 8. Rather, the through-hole 8 is not formed in the second region R2 of the top foil 4, so that the air film A in the second region R2 is prevented from flowing out to the outer peripheral side of the top foil 4 via the through-hole 8. Therefore, the pressure of the air film A capable of suitably supporting the rotor 102 can be ensured. More specifically, the pressure of the air film A at the angular position θ of 210 degrees can be maintained at a high positive pressure, and the rotor 102 can be stably supported.

As shown in FIG. 5, the pressure of the air film A has a different magnitude depending on the angular position θ. According to one embodiment, each of the first through-hole 8A, the second through-hole 8B, and the third through-hole 8C is disposed to correspond to the angular position θ, and thus the vibration stability of the rotor 102 can be further improved. The size of the diameter of each of the first through-hole 8A, the second through-hole 8B, and the third through-hole 8C may be different from each other, and the first through-hole 8A, the second through-hole 8B, and the third through-hole 8C may have shapes other than a circular shape, such as a rectangular shape.

The pressure of the air film A may have different magnitudes depending on the axial direction D1. According to one embodiment, each of the first through-hole 8A, the first axial direction through-hole 8D, and the second axial direction through-hole 8E is disposed to correspond to the magnitude of the pressure of the air film A in the axial direction D1, and thus the vibration stability of the rotor 102 can be further improved. The size of the diameter of each of the first through-hole 8A, the first axial direction through-hole 8D, and the second axial direction through-hole 8E may be different from each other, and the first through-hole 8A, the first axial direction through-hole 8D, and the second axial direction through-hole 8E may have shapes other than a circular shape, such as a rectangular shape.

In some embodiments, in the foil bearing device 1, the shape and position of each of the plurality of through-holes 8 are determined based on the weight of the rotor 102 and the rated rotation speed of the rotor 102 (that is, the magnitude of the negative pressure). In some embodiments, in the foil bearing device 1, the density or the number of the plurality of through-holes 8 is determined based on the weight of the rotor 102 and the rated rotation speed of the rotor 102.

In some embodiments, the plurality of through-holes 8 are formed in a portion at the angular position θ in a range of 240 degrees or more and less than 300 degrees in the first region R1 of the top foil 4. In this case, the through-hole 8 does not need to be formed in a portion where the angular position θ of the top foil 4 is in a range of 300 degrees or more and less than 360 degrees. According to such a configuration, in a case where the top foil 4 is configured to close the gap between the one end portion 10 and the other end portion 12, the strength of each of the one end portion 10 and the other end portion 12 can be maintained.

In some embodiments, the plurality of through-holes 8 include a large-diameter hole and a small-diameter hole having a diameter smaller than that of the large-diameter hole, which are disposed along the axial direction D1. In a developed view in which the inner surface 5 of the top foil 4 is developed, the distance of the large-diameter hole to an imaginary straight line passing through the center in the axial direction D1 of the top foil 4 is shorter than that of the small-diameter hole. In the air film A, in the first region R1, the absolute value of the negative pressure may be large on a center side in the axial direction D1. According to such a configuration, the negative pressure on the center side of the air film A can be effectively suppressed or eliminated.

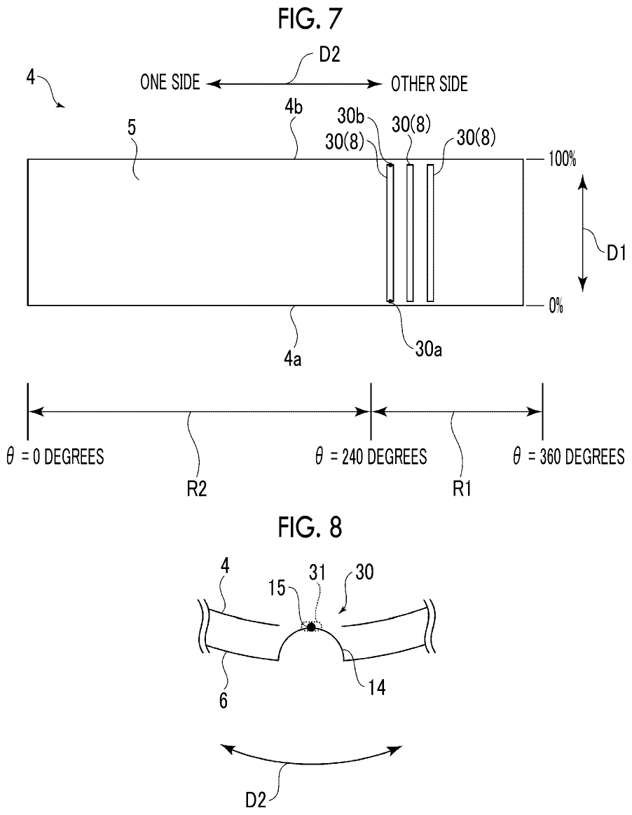

In one embodiment, the plurality of through-holes 8 each having a circular shape are formed in the top foil 4. However, the present disclosure is not limited to this form. FIG. 6 is a developed view of the inner surface 5 of the top foil 4 according to another embodiment as developed and viewed. FIG. 7 is a developed view of the inner surface 5 of the top foil 4 according to still another embodiment as developed and viewed. FIG. 8 is a diagram schematically showing a configuration of the top foil 4 according to still another embodiment.

In another embodiment, as illustrated in FIG. 6, one through-hole 8 is formed in the top foil 4. The through-hole 8 includes a slit 20 (8) having an axial direction cutout portion 22 and a pair of rotation direction cutout portions 24A and 24B.

The axial direction cutout portion 22 is cut out in a linear shape along the axial direction D1. Each of the pair of rotation direction cutout portions 24A and 24B is cut out in a linear shape from the axial direction cutout portion 22 toward the one side in the circumferential direction D2, which is an upstream side in the rotation direction. The pair of rotation direction cutout portions 24A and 24B are arranged side by side along the axial direction D1. The pair of rotation direction cutout portions 24A and 24B at least partially overlap each other in the axial direction D1. The pair of rotation direction cutout portions 24A and 24B face each other. The slit 20 has a sideway U-shape protruding toward the other side in the circumferential direction D2.

In the form illustrated in FIG. 6, one end 4a on one side in the axial direction D1 of the top foil 4 is set to a position of 0% with respect to the length in the axial direction D1 of the top foil 4. A position increases toward the other end 4b from the one end 4a of the top foil 4, and the other end 4b is defined as a position of 100% with respect to the length in the axial direction D1 of the top foil 4. One end 22a of the axial direction cutout portion 22 is located in a range of more than 0% and less than 10%, and the other end 22b is located in a range of more than 90% and less than 100%. One of the pair of rotation direction cutout portions 24A is cut out from the one end 22a of the axial direction cutout portion 22 toward the one side in the circumferential direction D2. The other of the pair of rotation direction cutout portions 24B is cut out from the other end 22b of the axial direction cutout portion 22 toward the one side in the circumferential direction D2.

According to the form illustrated in FIG. 6, the sideway U-shaped slit 20 is formed, so that when the pressure of the air film A becomes a negative pressure, a suction portion 4c of the top foil 4 surrounded by the slit 20 can be drawn toward the rotor 102, and the thickness of the air film A can be made substantially uniform (a parallel gap can be formed). Therefore, a decrease in the pressure of the air film A due to the air film A thickly spreading as the angular position θ increases is suppressed, and the pressure of the air film A can be prevented from becoming a negative pressure.

According to the form illustrated in FIG. 6, the one end 22a of the slit 20 is located in a range of more than 0% and less than 10%, and the other end 22b is located in a range of more than 90% and less than 100%. For this reason, the suction portions 4c of the top foil 4 can be ensured to extend in the axial direction D1, and it is possible to prevent the pressure of the air film A from becoming a negative pressure over the entire length or most of the axial direction D1.

In the form illustrated in FIG. 6, the slit 20 has a sideway U-shape. However, the present disclosure is not limited to this form. The slit 20 may have any configuration as long as the suction portion 4c is formed. For example, one of the pair of rotation direction cutout portions 24A is cut out toward the one side in the circumferential direction D2 from between the one end 22a and the other end 22b of the axial direction cutout portion 22.

In still another embodiment, as illustrated in FIG. 7, the through-hole 8 includes a long hole 30 (8) having a rectangular shape extending along the axial direction D1. The long hole 30 has one end 30a that is located in a range of more than 0% and less than 10% with respect to the length in the axial direction D1 of the top foil 4 described above, and the other end 30b that is located in a range of more than 90% and less than 100%. As illustrated in FIG. 8, the long hole 30 and an apex 15 of the bump portion 14 overlap each other in the circumferential direction D2 (the rotation direction of the rotor 102). The apex 15 of the bump portion 14 overlaps with a center 31 of the long hole 30 in the circumferential direction D2. The length of the long hole 30 in the circumferential direction D2 is smaller than the length of the bump portion 14 in the circumferential direction D2.

According to the form illustrated in FIGS. 7 and 8, even when the pressure of the air film A becomes a negative pressure, air is allowed to flow into the air film A having a negative pressure through the long hole 30, and thus the pressure of the air film A can be prevented from becoming a negative pressure. Further, when the pressure of the air film A becomes higher than a positive pressure, the long hole 30 is blocked by the bump portion 14 to suppress the outflow of the air film A. For this reason, the pressure of the air film A larger than the positive pressure can be ensured.

According to the form illustrated in FIG. 7, the long hole 30 has the one end 30a located in a range of more than 0% and less than 10%, and the other end 30b located in a range of more than 90% and less than 100%. Therefore, it is possible to prevent the pressure of the air film A from becoming a negative pressure over the entire length or most of the axial direction D1.

In each of the embodiments described above, a case has been described where only the plurality of circular through-holes 8A to 8E (the form illustrated in FIG. 3), the sideway U-shaped slit 20 (the form illustrated in FIG. 6), or the long hole 30 is formed in the top foil 4. In some embodiments, at least two of the circular through-hole 8A, the slit 20, and the long hole 30 are formed in the top foil 4.

The contents described in each of the embodiments described above are understood as follows, for example.

[1] A foil bearing device (1) according to the present disclosure is a foil bearing device that rotatably supports a rotor (102), the foil bearing device including:
an annular member (2) having an insertion hole (3) through which the rotor is inserted;
a top foil (4) having an arc-shaped cross section, which is disposed to surround an entire outer periphery of the rotor between an inner surface (7) of the annular member and an outer surface (110) of the rotor; and
a bump foil (6) that supports the top foil from an outer peripheral side of the top foil and that is supported on the inner surface of the annular member,
in which, when in a cross-sectional view taken along a direction orthogonal to an axial direction (D1) of the rotor, an angular position (θ) of an imaginary line (L) extending upward in a gravity direction (D4) from a center line (O1) of the top foil is set to 0 degrees, the angular position increases as the imaginary line rotates in a rotation direction of the rotor with the center line of the top foil as a rotation center, and the angular position when the imaginary line makes one rotation is defined as 360 degrees,
the top foil includes a first region (R1) in which the angular position at which at least one through-hole (8) penetrating the top foil is formed is in a range of 240 degrees or more and less than 360 degrees, and a second region (R2) in which the angular position at which a through-hole penetrating the top foil is not formed is in a range of 0 degrees or more and less than 240 degrees.

When the rotor rotates, in the first region where the angular position is in a range of 240 degrees or more and less than 360 degrees, the gap between the top foil and the rotor increases as the angular position increases. For this reason, there is a possibility that the pressure of the fluid film (air film) formed between the top foil and the rotor drops and becomes a negative pressure. The negative pressure serves as an exciting force that vibrates the rotor, and reduces the vibration stability of the rotor. According to the configuration of the above [1], since the through-hole is formed in the first region of the top foil, even when the pressure of the fluid film becomes a negative pressure, the fluid (air) on the outer peripheral side of the top foil flows into the fluid film through the through-hole, and the pressure of the fluid film is prevented from becoming a negative pressure. Therefore, it is possible to suppress an increase in the exciting force and to improve the vibration stability of the rotor.

Meanwhile, in a case where through-holes are formed over the entire periphery of the top foil, the pressure of the fluid film supporting the rotor decreases, the fluid film is thinned, and there is a possibility that the rotor comes into contact with the top foil. According to the configuration of the above [1], since a through-hole is not formed in the second region of the top foil, it is possible to suppress a decrease in the pressure of the fluid film and to suppress contact between the rotor and the top foil. In particular, the fluid film in the second region is often under a positive pressure, unlike the fluid film in the first region. Therefore, it is not necessary to allow the fluid to flow into the fluid film in the second region through a through-hole. Rather, a through-hole is not formed in the second region of the top foil, so that the fluid film in the second region is prevented from flowing out to the outer peripheral side of the top foil through a through-hole. Therefore, the pressure of the fluid film capable of suitably supporting the rotor can be ensured.

[2] In some embodiments, in the configuration described in the above [1],
the at least one through-hole includes a plurality of through-holes (8A, 8D, 8E) that are disposed along an axial direction of the rotor in the first region.

The pressure of the fluid film may have different magnitudes depending on the axial direction. According to the configuration of the above [2], the plurality of through-holes are disposed to correspond to the magnitude of the pressure in the axial direction of the fluid film, and thus the vibration stability of the rotor can be further improved.

[3] In some embodiments, in the configuration described in the above [1] or [2],
the at least one through-hole includes a first through-hole (8A) and a second through-hole (8B) having an angular position different from an angular position of the first through-hole in the first region.

The pressure of the fluid film has a magnitude that varies depending on the angular position. According to the configuration of the above [3], the first through-hole and the second through-hole are disposed to correspond to the angular positions, and thus the vibration stability of the rotor can be further improved.

[4] In some embodiments, in the configuration described in any one of the above [1] to [3],
the at least one through-hole includes a slit (20) that includes an axial direction cutout portion (22) cut out along an axial direction of the rotor, and a pair of rotation direction cutout portions (24A, 24B) cut out from the axial direction cutout portion toward an upstream side in the rotation direction and aligned along the axial direction.

According to the configuration of the above [4], when the pressure of the fluid film becomes a negative pressure, the portion of the top foil surrounded by the slit is drawn toward the rotor, and the size of the gap between the portion of the top foil and the rotor can be made uniform or substantially uniform. Therefore, it is possible to suppress a decrease in the pressure of the fluid film due to the gap increasing as the angular position increases, and to prevent the pressure of the fluid film from becoming a negative pressure.

[5] In some embodiments, in the configuration described in the above [4],
when one end (4a) of the top foil in the axial direction is defined as a position of 0% with respect to a length of the top foil in the axial direction, the position increases toward the other end (4b) from the one end of the top foil, and the other end is defined as a position of 100% with respect to the length of the top foil in the axial direction,
the axial direction cutout portion has one end (22a) that is located in a range of more than 0% and less than 10%, and the other end (22b) that is located in a range of more than 90% and less than 100%,
one of the pair of rotation direction cutout portions (24A) is cut out from the one end of the axial direction cutout portion toward the upstream side in the rotation direction, and
the other of the pair of rotation direction cutout portions (24B) is cut out from the other end of the axial direction cutout portion toward the upstream side in the rotation direction.

According to the configuration of the above [5], it is possible to prevent the pressure of the fluid film from becoming a negative pressure over the entire length or most of the axial direction.

[6] In some embodiments, in the configuration described in any one of the above [1] to [5],
the bump foil includes a bump portion (14) that protrudes toward the top foil, and
the at least one through-hole and an apex (15) of the bump portion overlap each other in the rotation direction of the rotor.

According to the configuration of the above [6], even when the pressure of the fluid film becomes a negative pressure, the fluid (air) is allowed to flow into the fluid film having a negative pressure through the through-hole, and thus the pressure of the fluid film can be prevented from becoming a negative pressure. Further, when the pressure of the fluid film becomes higher than a positive pressure, the through-hole is blocked by the bump portion, and the pressure of the fluid film higher than the positive pressure can be ensured.

### REFERENCE SIGNS LIST

1: foil bearing device
2: annular member
3: insertion hole
4: top foil
4a: one end of top foil
4b: other end of top foil
5: inner surface of top foil
6: bump foil
7: inner surface of annular member
8: through-hole
8A: first through-hole
8B: second through-hole
14: bump portion
15: apex
20: slit
22: axial direction cutout portion
22a: one end of axial direction cutout portion
22b: other end of axial direction cutout portion
24A: one of a pair of rotation direction cutout portions
24B: the other of a pair of rotation direction cutout portions
30: long hole
100: electric compressor
102: rotor
104: electric motor
106: impeller
108: housing
110: outer surface of rotor
A: air film
D1: axial direction
D2: circumferential direction
D3: radial direction
D4: gravity direction
L: imaginary line
O1: center line
R1: first region
R2: second region

1. A foil bearing device that rotatably supports a rotor, the foil bearing device comprising:
an annular member having an insertion hole through which the rotor is inserted;
a top foil having an arc-shaped cross section, which is disposed to surround an entire outer periphery of the rotor between an inner surface of the annular member and an outer surface of the rotor; and
a bump foil that supports the top foil from an outer peripheral side of the top foil and that is supported on the inner surface of the annular member,
wherein, when in a cross section orthogonal to an axis of the rotor, an angular position of an imaginary line extending upward in a gravity direction from a center line of the top foil is set to 0 degrees, the angular position increases as the imaginary line rotates in a rotation direction of the rotor with the center line of the top foil as a rotation center, and the angular position when the imaginary line makes one rotation is defined as 360 degrees,
the top foil includes a first region in which the angular position at which at least one through-hole penetrating the top foil is formed is in a range of 240 degrees or more and less than 360 degrees, and a second region in which the angular position at which a through-hole penetrating the top foil is not formed is in a range of 0 degrees or more and less than 240 degrees.

2. The foil bearing device according to claim 1,
wherein the at least one through-hole includes a plurality of through-holes that are disposed along an axial direction of the rotor in the first region.

3. The foil bearing device according to claim 1,
wherein the at least one through-hole includes a first through-hole and a second through-hole having an angular position different from an angular position of the first through-hole in the first region.

4. The foil bearing device according to claim 1,
wherein the at least one through-hole includes a slit that includes an axial direction cutout portion cut out along an axial direction of the rotor, and a pair of rotation direction cutout portions cut out from the axial direction cutout portion toward an upstream side in the rotation direction and aligned along the axial direction.

5. The foil bearing device according to claim 4,
wherein when one end of the top foil in the axial direction is defined as a position of 0% with respect to a length of the top foil in the axial direction, the position increases toward the other end from the one end of the top foil, and the other end is defined as a position of 100% with respect to the length of the top foil in the axial direction,
the axial direction cutout portion has one end that is located in a range of more than 0% and less than 10%, and the other end that is located in a range of more than 90% and less than 100%,
one of the pair of rotation direction cutout portions is cut out from the one end of the axial direction cutout portion toward the upstream side in the rotation direction, and
the other of the pair of rotation direction cutout portions is cut out from the other end of the axial direction cutout portion toward the upstream side in the rotation direction.

6. The foil bearing device according to claim 1,
wherein the bump foil includes a bump portion that protrudes toward the top foil, and
the at least one through-hole and an apex of the bump portion overlap each other in the rotation direction of the rotor.
